(19) United States
(12) Patent Application Publication
(10) Pub. No.: US 2025/0200831 A1
(43) Pub. Date: Jun. 19, 2025

(54) METHOD FOR AUTOMATICALLY GENERATING SKETCH IMAGE, APPARATUS FOR AUTOMATICALLY GENERATING SKETCH IMAGE USING THE METHOD, AND COMPUTER READABLE MEDIUM HAVING PROGRAM FOR PROCESSING THE METHOD

(71) Applicant: Korea Advanced Institute of Science and Technology, Daejeon (KR)

(72) Inventors: Junyong NOH, Daejeon (KR); Changwook SEO, Daejeon (KR)

(73) Assignee: Korea Advanced Institute of Science and Technology, Daejeon (KR)

(21) Appl. No.: 18/790,208

(22) Filed: Jul. 31, 2024

(30) Foreign Application Priority Data
Dec. 15, 2023 (KR) 10-2023-0182826
Apr. 22, 2024 (KR) 10-2024-0053597

(51) Int. Cl. G06T 11/00; G06V 10/44; G06V 10/46; G06V 10/74; G06V 10/774

(52) U.S. Cl. CPC G06T 11/001; G06V 10/44; G06V 10/46; G06V 10/761; G06V 10/774

(57) ABSTRACT

A method for automatically generating a sketch image according to an embodiment may include inputting a color image, and extracting a shape data from the color image, inputting a reference image, and extracting a style data from the reference image, and outputting the sketch image based on the shape data and the style data.

### BACKGROUND

### 1. Field

Embodiments relate to a method for automatically generating a sketch image, an apparatus for automatically generating a sketch image using the method, and a computer readable medium having program for processing the method. More particularly, embodiments relate to the method for automatically generating a sketch image based on a deep learning, the apparatus for automatically generating a sketch image using the method, and the computer readable medium having program for processing the method.

### 2. Description of the Related Art

With a development of artificial intelligence technology including a deep learning, image generation models using the artificial intelligence technology may automatically generate images. These image generation models have an ability to create and modify new images by learning large amounts of data, and may operate based on algorithms such as generative adversarial networks (GAN). These image generation models may be used in areas such as artistic creativity, design, simulation, data augmentation, and game development. Recently, research is being conducted to develop new business models using image generation models and to apply image generation models to various industries.

### SUMMARY

Embodiments provide a method for automatically generating a sketch image with improved a sketch style extraction accuracy and a learning ability.

Embodiments provide an apparatus for automatically generating a sketch image using the method for automatically generating the sketch image.

A method for automatically generating a sketch image according to an embodiment may include inputting a color image, and extracting a shape data from the color image, inputting a reference image, and extracting a style data from the reference image, and outputting the sketch image based on the shape data and the style data.

In an embodiment, the extracting the shape data may include extracting a shape feature from the color image by a first encoder, and extracting a spatial attention data from the shape feature by a spatial attention block.

In an embodiment, the extracting the style data may include extracting a style feature from the reference image by a second encoder, and extracting a channel attention data from the style feature by a channel attention block.

In an embodiment, a number of channels included in the shape data may be equal to or greater than a number of channels included in the style data.

In an embodiment, the outputting the sketch image may include performing a first operation of an adaptive instance normalization on the spatial attention data and the channel attention data, inputting an output of the first operation into a plurality of residual blocks, and generating the sketch image by inputting an output of the residual blocks into a decoder.

In an embodiment, the first operation may be performed by a first normalization operation block, and an input of the first normalization operation block may be a value obtained by performing a Hadamard product operation between the shape feature and the spatial attention data and a value obtained by performing the Hadamard product operation between the style feature and the channel attention data.

In an embodiment, the outputting the sketch image may further include performing a second operation of the adaptive instance normalization on the shape feature and the style feature, and inputting an output of the second operation into the plurality of residual blocks.

In an embodiment, the method may further include learning a process of extracting a sketch style from an image based on the color image and the reference image, and the process of extracting the sketch style from the image may be learned based on a loss function.

In an embodiment, the loss function may include a style loss function, and in the learning the process, the style loss function may compare the reference image and the color image.

In an embodiment, the style loss function may perform an operation according to an [equation 1] below.

$${L}_{S t y l e} = {E}_{O , {R}_{i}} [ {‖ {C}_{w} ( 0 ) - {C}_{w} ( {R}_{i} ) ‖}_{1} ] \qquad [ equation 1 ]$$

where, L_{style} is the style loss function, C_{w} is a pre-trained model, Rᵢ is the reference image, and O is the sketch image.

In an embodiment, the method may further include outputting a reconstructed image by coloring the sketch image after the outputting the sketch image.

In an embodiment, the loss function may include a cyclic loss function, and in the learning the process, the cyclic loss function may compare the color image and the reconstructed image.

In an embodiment, the cyclic loss function may perform an operation according to an [equation 2] below.

$${L}_{C y c} = {E}_{{C}_{i} , {R}_{o}} [ {‖ {C}_{i} - {R}_{o} ‖}_{1} ] \qquad [ equation 2 ]$$

where, L_{Cyc} is the cyclic loss function, Cᵢ is the color image, and R_{O} is the reconstructed image.

In an embodiment, in the learning the process, a first edge-detected image may be generated from the color image through an edge-detection process, and a second edge-detected image may be generated from the reconstructed image through the edge-detection process

In an embodiment, the loss function may include a line loss function, and in the learning the process, the line loss function may compare the first edge-detected image and the second edge-detected image.

In an embodiment, the line loss function may perform an operation according to an [equation 3] below.

$${L}_{Line} = {E}_{{C}_{i} , {R}_{o}} [ {\sum }_{l} {‖ {∅}_{l} ( HED ( {C}_{i} ) ) - {∅}_{l} ( HED ( {R}_{o} ) ) ‖}_{1} ] \qquad [ equation 3 ]$$

where, Lₗᵢₙₑ is the line loss function, HED(Cᵢ) is the first edge-detected image, HED(R_{O}) is the second edge-detected image, and Øₗ is an activation map located in a lth layer of a deep learning network for comparing the first edge-detected image and the second edge-detected image.

In an embodiment, the loss function may include an adversarial loss function, and the method may further include discriminating a similarity of a sketch style of the reference image and a sketch style of the sketch image through the adversarial loss function by a discriminator.

In an embodiment, the adversarial loss function may perform an operation according to an [equation 4] below.

$${L}_{adv} = {E}_{{R}_{i}} [ log ( D ( {R}_{i} ) ) ] + {E}_{O} [ log ( 1 - D ( O ) ) ] \qquad [ equation 4 ]$$

where, L_{adv} is the adversarial loss function, D is the discriminator, Rᵢ is the reference image, and O is the sketch image.

An apparatus for automatically generating a sketch image may include a first generator configured to receive a color image and a reference image and configured to output the sketch image which has a same shape as the color image and a same sketch style as the reference image, and a discriminator configured to discriminate a similarity of a sketch style of the reference image and a sketch style of the sketch image.

An example non-transitory computer-readable storage medium has stored thereon program instructions, which when executed by at least one hardware processor, performs inputting a color image, and extracting a shape data from the color image, inputting a reference image, and extracting a style data from the reference image, and outputting a sketch image based on the shape data and the style data.

In the method for automatically generating the sketch image according to embodiments of the present disclosure, a color image and a reference image may input, and a sketch image which has a same shape as the color image and a same sketch style as the reference image may be generated from the color image and the reference image. Accordingly, the sketch image may be generated when a shape of the color image and a shape of the reference image are different from each other, so a speed of generating the sketch image using the automatic sketch image generation method may be improved.

In addition, in the method for automatically generating the sketch image, the reference image and the sketch image may be compared and learned through the style loss function. Accordingly, a sketch style may be accurately extracted from an input image using the method for automatically generating the sketch image. In addition, in the method for automatically generating the sketch image, the sketch style may be more accurately extracted from the input image by calculating a total loss function using the style loss function, a cyclic loss function, a line loss function, and an adversarial loss function.

### BRIEF DESCRIPTION OF THE DRAWINGS

Illustrative, non-limiting embodiments will be more clearly understood from the following detailed description in conjunction with the accompanying drawings.

FIG. 1 is a block diagram for explaining an apparatus for automatically generating a sketch image according to an embodiment of the present disclosure.

FIG. 2 is a block diagram for explaining a first generator included in the apparatus for automatically generating the sketch image of FIG. 1.

FIG. 3 is a block diagram for explaining a second generator included in the apparatus for automatically generating the sketch image of FIG. 1.

FIG. 4 is a block diagram for explaining a learner included in the apparatus for automatically generating the sketch image of FIG. 1.

FIG. 5 is a diagram for explaining a style loss function of FIG. 4.

FIG. 6 is a diagram for explaining a line loss function of FIG. 4.

FIG. 7 is a flowchart illustrating a method of outputting a sketch image using the apparatus for automatically generating the sketch image of FIG. 1.

FIG. 8 is a flowchart illustrating a method of learning a sketch image using the apparatus for automatically generating the sketch image of FIG. 1.

### DETAILED DESCRIPTION OF THE EMBODIMENTS

The present inventive concept now will be described more fully hereinafter with reference to the accompanying drawings, in which embodiments of the present invention are shown. The present inventive concept may, however, be embodied in many different forms and should not be construed as limited to the embodiments set forth herein.

Rather, these embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, a method for automatically generating a sketch image, an apparatus for automatically generating a sketch image using the method in accordance with embodiments will be described in more detail with reference to the accompanying drawings. The same reference numerals are used for the same components in the drawings, and redundant descriptions of the same components will be omitted.

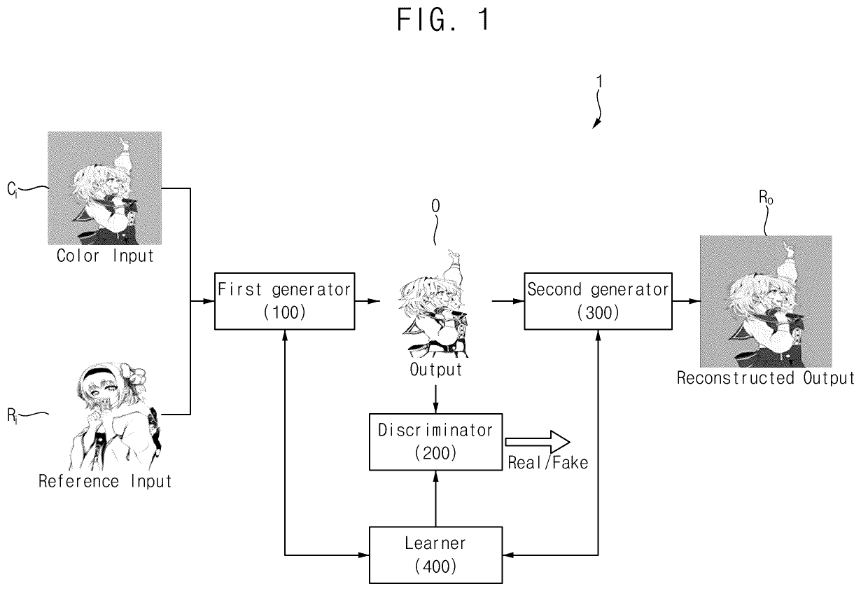

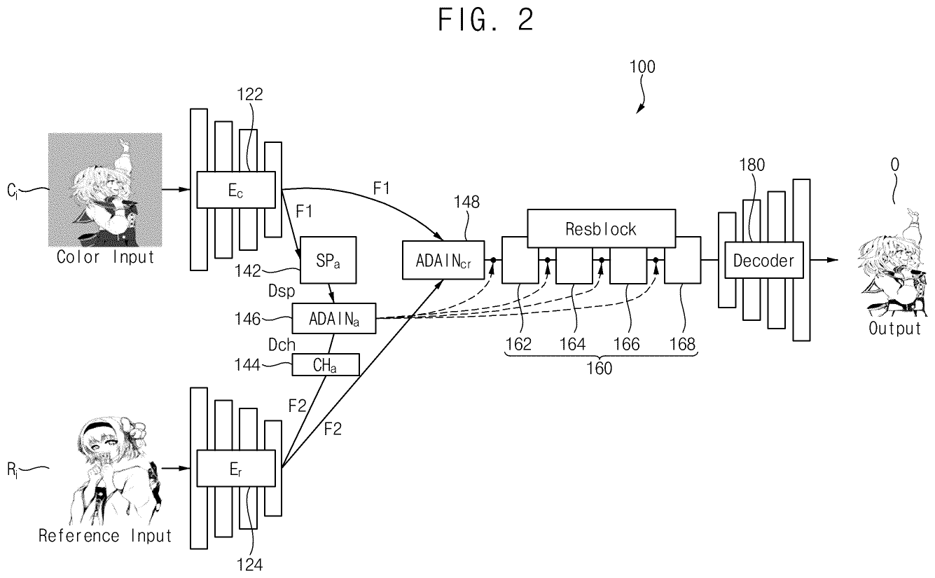

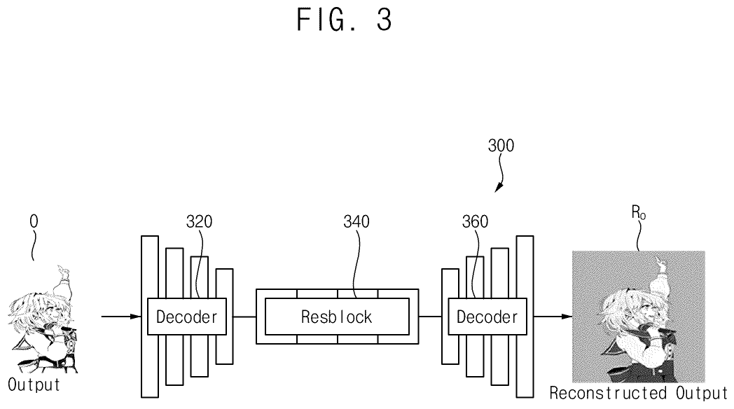

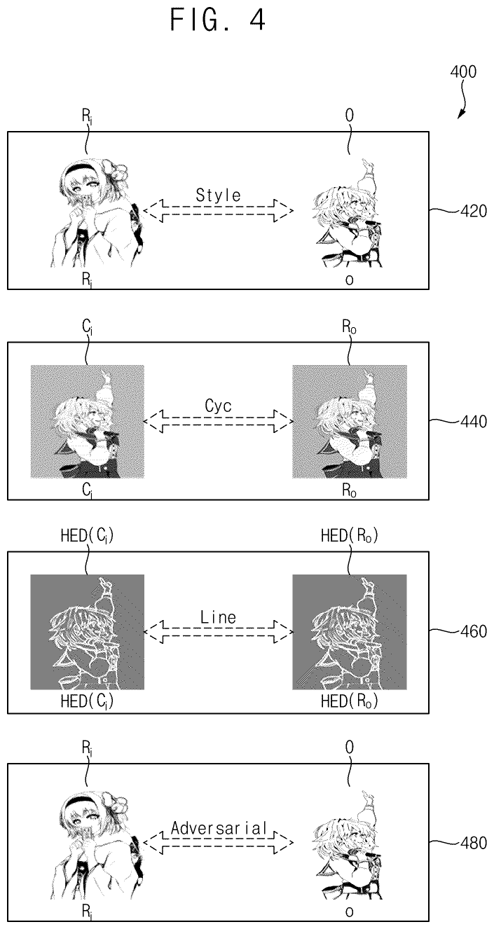

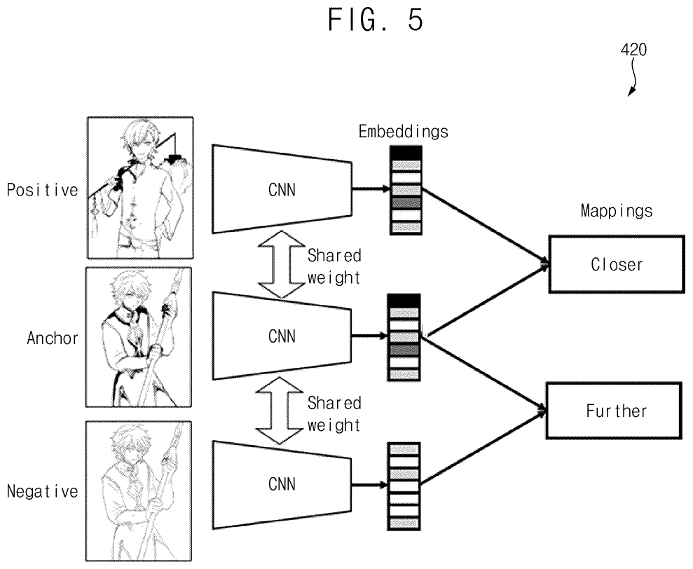

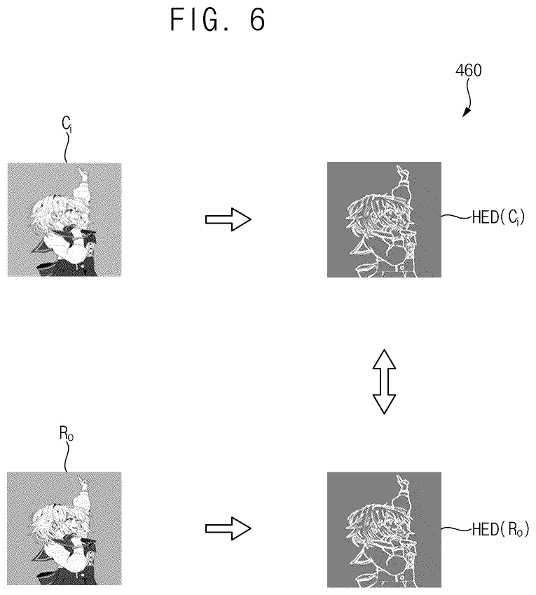

FIG. 1 is a block diagram for explaining an apparatus for automatically generating a sketch image according to an embodiment of the present disclosure. FIG. 2 is a block diagram for explaining a first generator included in the apparatus for automatically generating the sketch image of FIG. 1. FIG. 3 is a block diagram for explaining a second generator included in the apparatus for automatically generating the sketch image of FIG. 1. FIG. 4 is a block diagram for explaining a learner included in the apparatus for automatically generating the sketch image of FIG. 1. FIG. 5 is a diagram for explaining a style loss function of FIG. 4. FIG. 6 is a diagram for explaining a line loss function of FIG. 4.

Referring to FIG. 1, an apparatus for automatically generating a sketch image 1 according to an embodiment of the present disclosure may include a first generator 100, a discriminator 200, a second generator 300, and a learner 400.

The apparatus for automatically generating the sketch image 1 may receive a color image Cᵢ and a reference image Rᵢ. The apparatus for automatically generating the sketch image may output a sketch image O which has a same shape as the color image Cᵢ and a same sketch style as the reference image Rᵢ. For example, the color image Cᵢ may be a colored image. The reference image Rᵢ may be an image which has a specific sketch style. In an embodiment, a shape of the color image Cᵢ and a shape of the reference image Rᵢ may be different from each other. Specifically, when the apparatus for automatically generating the sketch image 1 receives a pair of images in which the shape of the color image Cᵢ and the shape of the reference image Rᵢ are different from each other, apparatus for automatically generating the sketch image 1 may generate the sketch image which has the same shape as the color image Cᵢ and the same sketch style as the reference image Rᵢ. In other words, the apparatus for automatically generating the sketch image 1 may output the sketch image O when a pair of images in which the shape of the color image Cᵢ and the shape of the reference image Rᵢ are the same are not input into the apparatus for automatically generating the sketch image 1. However, the present disclosure may not be limited to this, and the shape of the color image Cᵢ and the shape of the reference image Rᵢ may be same. In addition, the apparatus for automatically generating the sketch image 1 may output a reconstructed image R_{O} by coloring the sketch image O output from the apparatus for automatically generating the sketch image 1.

In an embodiment, the apparatus for automatically generating the sketch image 1 may be an artificial intelligence model based on a generative adversarial network. For example, the first generator 100 and the second generator 300 may correspond to a generator of the generative adversarial network. In addition, the discriminator 200 may correspond to a discriminator of the generative adversarial network.

Referring to FIGS. 1 and 2, the first generator 100 may include a first encoder 122, a second encoder 124, a spatial attention block 142, a channel attention block 144, a first normalization operation block 146, a second normalization operation block 148, a plurality of residual blocks 160, and a decoder 180.

The first encoder 122 may extract a shape feature F1 from the color image Cᵢ. For example, the first encoder 122 may extract a shape feature F1 from the color image Cᵢ through an operation process using a convolution and a pooling. The second encoder 124 may extract a style feature F2 from the reference image Rᵢ. For example, the second encoder 124 may extract a style feature F2 from the reference image Rᵢ through an operation process using a convolution and a pooling. A structure of the first encoder 122 and a structure of the second encoder 124 may be substantially same. However, the first encoder 122 and the second encoder 124 may not share data with each other.

The spatial attention block 142 may extract a spatial attention data Dₛₚ from the shape feature F1. For example, the spatial attention data Dₛₚ may be a feature map extracted through the spatial attention block 142. The channel attention block 144 may extract a channel attention data D_{ch} from the style feature F2. For example, the channel attention data D_{ch} may be a feature map extracted through the channel attention block 144. In addition, a feature size (e.g., a number of channels, a height of an image, and a width of the image) of each of the spatial attention data Dₛₚ and the channel attention data D_{ch} may be equal to each other. However, the present disclosure may not be limited to this, and the feature size of the spatial attention data Dₛₚ and the channel attention data D_{ch} may be different from each other.

In an embodiment, a structure of each of the spatial attention block 142 and the channel attention block 144 may be substantially same or similar to a structure of a convolution block attention module (CBAM). However, the structure of each of the spatial attention block 142 and the channel attention block 144 of the present disclosure may not be limited to this.

In an embodiment, when a feature size illustrating a number of channels, a height of an image, and a width of the image, which the shape feature F1 has, is C*H*W, the spatial attention data Dₛₚ may be a data operated through the spatial attention block 142 according to an [equation 1] below.

Where, C is a number of channels which an input data has, H is a height of an image which the input data has, and W is a width of the image which the input data has.

$${SP}_{a} ( {E}_{c} ( {C}_{i} ) ) = σ ( {f}^{3 * 3} ( [ {AvgPool}^{SP} ( {E}_{c} ( {C}_{i} ) ) ; Max {Pool}^{SP} ( {E}_{c} ( {C}_{i} ) ) ] ) ) = σ ( {f}^{3 * 3} ( [ {{E}_{C} ( {C}_{i} )}_{avg}^{SP} ; {{E}_{C} ( {C}_{i} )}_{max}^{SP} ] ) ) \qquad [ equation 1 ]$$

Where, SPₐ is an operation through the spatial attention block 142, E_{c} is an operation through the first encoder 122, E_{c}(Ct) is the style feature F1, AvgPool^{SP} is an operation using an average pooling, MaxPool^{SP} is an operation using a maximum pooling, f^{3*3} is an operation using a convolution through a 3*3 kernel filter, and o is an operation using a sigmoid function.

For example, the spatial attention block 142 may extract the spatial attention data Dₛₚ by sequentially performing an operation using the average pooling and the maximum pooling on the input shape feature F1, an operation using the convolution through the 3*3 kernel filter, and an operation using the sigmoid function. The spatial attention data Dₛₚ may have 1*H*W data. Through operations using the average pooling and the maximum pooling in the spatial attention block 142, a feature size of the shape feature F1 may be changed from C*H*W to 1*H*W. Accordingly, a feature size of spatial attention data Dₛₚ may be 1*H*W, and a number of channels may be 1.

In an embodiment, when a feature size illustrating a number of channels, a height of an image, and a width of the image, which the style feature F2 has, is C*H*W, the channel attention data D_{ch} may be a data operated through the channel attention block 144 according to an [equation 2] below.

$${CH}_{a} ( {E}_{r} ( {R}_{i} ) ) = σ ( MLP ( {AvgPool}^{CH} ( {E}_{r} ( {R}_{i} ) ) ) + MLP ( Max {Pool}^{CH} ( {E}_{r} ( {R}_{i} ) ) ) ) = σ ( {W}_{1} ( {W}_{0} ( {{E}_{r} ( {R}_{i} )}_{avg}^{CH} ) ) + {W}_{1} ( {W}_{0} ( {{E}_{r} ( {R}_{i} )}_{max}^{CH} ) ) ) \qquad [ equation 2 ]$$

Where, CHₐ is an operation through the channel attention block 144, Eᵣ is an operation through the second encoder 124, Eᵣ(Rᵢ) is the style feature F2, MLP is a multi-layer perceptron, and W₀ and W₁ are weights of the multi-layer perceptron.

For example, the channel attention block 144 may extract the channel attention data D_{ch} by sequentially performing an operation using the average pooling and the maximum pooling on the input style feature F2, an operation using the multi-layer perceptron, and an operation using the sigmoid function. Specifically, the channel attention block 144 may shrink a picture size by 1/r twice through hidden layers after performing the average pooling on the style feature F2. In addition, the channel attention block 144 may shrink the picture size twice by 1/r through the hidden layers after performing the maximum pooling on the style feature F2. Here, r is a shrinkage ratio of the hidden layers included in the multilayer perceptron. In an embodiment, the shrinkage ratio may be about 16. However, the shrinkage ratio of the present disclosure may not be limited to this and may have various values.

The channel attention data D_{ch} may have C*1*1 data. Through operations using the average pooling and the maximum pooling in the channel attention block 144, a feature size of the style feature F2 may be changed from C*H*W to C*1*1. Accordingly, the feature size of the channel attention data D_{ch} may be C*1*1, and each of height of an image and a width of the image may be 1.

The first normalization operation block 146 may receive the spatial attention data Dₛₚ and the channel attention data D_{ch}, and perform a first operation of an adaptive instance normalization (ADAIN). The first normalization operation block 146 may transmit an output operated by the first operation to a plurality of residual blocks 160. In an embodiment, the first operation of the first normalization operation block 146 may be operated according to [equation 3] below. Where, the adaptive instant normalization refers to a process of performing normalization using an average and a standard deviation (or a variance) of input values.

$${ADAIN}_{a} ( {E}_{C} ( {C}_{i} ) ⊙ {SP}_{a} ( {E}_{C} ( {C}_{i} ) ) , {E}_{r} ( {R}_{i} ) ⊙ {CH}_{a} ( {E}_{r} ( {R}_{i} ) ) ) \qquad [ equation 3 ]$$

Where, ⊙ is an operator of Hadamard product.

For example, an input of the first normalization operation block 146 may be a value obtained by performing a Hadamard product operation between the shape feature F1 and the spatial attention data Dₛₚ and a value obtained by performing a Hadamard product operation between the style feature F2 and the channel attention data D_{ch}.

The second normalization operation block 148 may receive the shape feature F1 and the style feature F2 and output the shape feature F1 and the style feature F2 into the plurality of residual blocks 160. For example, the second normalization operation block 148 may receive the shape feature F1 and the style feature F2 and perform a second operation of the adaptive instant normalization.

In an embodiment, the first operation of the first normalization operation block 146 and the second operation of the second normalization operation block 148 may be performed simultaneously. That is, the first normalization operation block 146 and the second normalization operation block 148 may simultaneously transmit an operated data to the plurality of residual blocks 160.

The plurality of residual blocks 160 may include a first residual block 162, a second residual block 164, a third residual block 166, and a fourth residual block 168. In FIG. 1, the plurality of residual blocks 160 illustrates four residual blocks, but a number of the plurality of residual blocks 160 in the present disclosure may not be limited this. For example, the number of residual blocks 160 may be 3 or less or 5 or more. The apparatus for automatically generating the sketch image 1 may extract features for generating the sketch image O through the first, second, third, and fourth residual blocks 162, 164, 166, and 168.

The first residual block 162, the second residual block 164, the third residual block 166, and the fourth residual block 168 may perform operations using a convolution. A first output through the first operation and a second output through the second operation may input to the first residual block 162. The first output may input to each of the first, second, third, and fourth residual blocks 162, 164, 166, and 168. Specifically, the first output may be concatenated with the second output which input to the first residual block 162.

The first output may be concatenated with the output of the first residual block 162 and input to the second residual block 164. A number of dimensions of the first output may be larger than a number of dimensions of the output of the first residual block 162. A number of dimensions of an input of the second residual block 164 where the first output and the output of the first residual block 162 are concatenated may be equal to a number of dimensions of the output of the first residual block 162.

The first output may be concatenated with the output of the second residual block 164 and input to the third residual block 166. A number of dimensions of the first output may be larger than a number of dimensions of the output of the second residual block 164. A number of dimensions of an input of the third residual block 166 where the first output and the output of the second residual block 164 are concatenated may be equal to a number of dimensions of the output and the output of the second residual block 164.

The first output may be concatenated with the output of the third residual block 166 and input to the fourth residual block 168. A number of dimensions of the first output may be larger than a number of dimensions of the output of the third residual block 166. A number of dimensions of the input of the fourth residual block 168 where the first output and the output of the third residual block 166 are concatenated may be equal to the number of dimensions of the output of the third residual block 166.

The decoder 180 may receive an output of the fourth residual block 168 and output the sketch image O. For example, the decoder 180 may generate the sketch image O based on the output of the fourth residual block 168.

The discriminator 200 may receive the sketch image O from the decoder 180. For example, the discriminator 200 may discriminate a similarity of a sketch style of the reference image Rᵢ and a sketch style of the sketch image O. The decoder 180 and the discriminator 200 generate the sketch image O based on contents learned in the learner 400, and discriminate the similarity of the input reference image Rᵢ and the generated sketch image O, respectively.

Referring to FIGS. 1, 2, and 3, the second generator 200 may include an encoder 320, a plurality of residual blocks 340, and a decoder 360.

The second generator 300 may generate the reconstructed image Rₒ for learning. For example, the second generator 300 may generate the reconstructed image by coloring the sketch image O generated by the first generator 100. Specifically, the sketch image O may input to the encoder 320. An output of the encoder 320 may input to the residual blocks 340, and the residual blocks 340 may extract features to generate the reconstructed image Rₒ. An output of the residual blocks 340 may input to the decoder 360, and the decoder 360 may generate the reconstructed image Rₒ.

Referring to FIGS. 1, 2, 3, and 4, the learner 400 may receive the color image Cᵢ, the reference image Rᵢ, the sketch mage O, the reconstructed image Rₒ, the first edge-detected image HED(Cᵢ), and the second edge-detected image HED(Rₒ). The learner 400 may include first learner 420, the second learner 440, the third learner 460, and the fourth learner 480. The learner 400 may learn a process of extracting a sketch style based on a loss function. In addition, the apparatus for automatically generating sketch image 1 may output the sketch image O which has a same shape as the color image Cᵢ and has a same sketch style as the reference image Rᵢ through the learner 400.

Referring to FIGS. 1, 2, 3, 4, and 5, the loss function may include a style loss function. The first learner 420 may compare the reference image Rᵢ and the sketch image O based on style loss function. The first learner 420 may perform a contrastive leaning using a learned data. For example, the first learner 420 may already have learned through an operation process using the style loss function from a pair of images that have a same shape and different sketch styles. The style loss function may perform an operation according to an [equation 4] below.

$${L}_{style} = {E}_{O , {R}_{i}} [ {‖ {C}_{w} ( O ) - {C}_{w} ( R ) ‖}_{1} ] \qquad [ equation 4 ]$$

Where, the L_{style} is the style loss function, C_{w} is a pre-trained model, E is an expectation.

The first learner 420 may receive a positive image, an anchor image, and a negative image. The positive image and the anchor image may form a positive pair with a same or similar sketch style. The positive image and the anchor image may have different shapes. In addition, the anchor image and the negative image may form a negative pair with different sketch styles. The anchor image and the negative image may have a same shape.

The first learner 420 may map the anchor image and the positive image in order to locate the anchor image and the positive to be close to each other. In addition, the first learner 420 may map the anchor image and the negative image in order to locate the anchor image and the negative image to be far from each other. In addition, the first learner 420 may learn whether images input to the first learner 420 are positive pairs and negative pairs through a convolutional neural network (CNN). A data about whether the images input to the first learner 420 are the positive pair and the negative pair may be shared through the convolutional neural network. Accordingly, as learning is accumulated, an accuracy of the learning results of the first learner 420 may be improved.

A data learned through the first learner 420 may be stored in the first generator 100. Accordingly, the similarity of the sketch style between the input reference image Rᵢ and the output sketch image O may be improved.

The loss function may include a cyclic loss function. The second learner 440 may include the cyclic loss function. The second learner 440 may compare the color image Cᵢ and the reconstructed image Rₒ based on the cyclic loss function. For example, the second learner 440 may learn by comparing a similarity of shapes between the color image Cᵢ and the reconstructed image Rₒ. The cyclic loss function may perform an operation according to an [equation 5] below.

$${L}_{Cyc} = {E}_{{C}_{i} , {R}_{o}} [ {‖ {C}_{i} - {R}_{o} ‖}_{1} ] \qquad [ equation 5 ]$$

Where, L_{Cyc} is the cyclic loss function.

Referring to FIGS. 1, 2, 3, 4, 5, and 6, the third learner 460 may extract the first edge-detected image HED(Cᵢ) from the color image Cᵢ. In addition, the third learner 460 may extract the second edge-detected image HED(Rₒ) from the reconstructed image Rₒ. For example, the third learner 460 may extract the first edge-detected image HED(Cᵢ) and the second edge-detected image HED(Rₒ) using a holistically-nested edge detection (HED).

The first edge-detected image HED(Cᵢ) may be an image in which an edge of the color image Cᵢ is detected. In addition, the second edge-detected image HED(Rₒ) may be an image in which an edge of the reconstructed image Rₒ is detected.

The loss function may include a line loss function. The third learner 460 may compare the first edge-detected image HED(Cᵢ) and the second edge-detected image HED(Rₒ) based on the line loss function. In an embodiment, the line loss function may include a deep learning network for comparing the first edge-detected image HED(Cᵢ) and the second edge-detected image HED(Rₒ). For example, the deep learning network may include VGG 16, VGG 19, and the like. In an embodiment, the line loss function may perform an operation according to [equation 6] below.

$${L}_{Line} = {E}_{{C}_{i} , {R}_{o}} [ {\sum }_{l} {‖ {∅}_{l} ( HED ( {C}_{i} ) ) - {∅}_{l} ( HED ( {R}_{o} ) ) ‖}_{1} ] \qquad [ equation 6 ]$$

Where, Lₗᵢₙₑ is the line loss function, and Øₗ is an activation map located in a lth layer of the deep learning network for comparing the first edge-detected image HED(Cᵢ) and the second edge-detected image HED(Rₒ).

Specifically, the third learner 460 may operate a difference between first edge-detected image HED(Cᵢ) and the second edge-detected image HED(Rₒ) through the deep learning network, and may perform an operation to merge the difference over a plurality of activation maps located in plurality of layers of the deep learning network.

The loss function may include an adversarial loss function. The fourth learner 480 may train the discriminator 200 based on the adversarial loss function. In an embodiment, the adversarial loss function may perform an operation according to [equation 7] below.

$${L}_{adv} = {E}_{{R}_{i}} [ log ( D ( {R}_{i} ) ) ] + {E}_{O} [ log ( 1 - D ( O ) ) ] \qquad [ equation 7 ]$$

Where, L_{adv} is the adversarial loss function, D is the discriminator 200.

The first, second, and third learners 420, 440, and 460 may transmit data learned through the first, second, and third learners 420, 440, and 460 to the first generator 100 and the second generator 300. The fourth learner 480 may transmit data learned through the fourth learner 480 to the discriminator 200. A total loss, in a form of multiplying a constant to each of the style loss function, the cyclic loss function, the line loss function, and the adversarial loss function included in the first, second, third, and fourth learners 420, 440, 460, and 480, may be defined. For deceiving discriminator 200 to discriminating that the sketch image O is real, a minimum value of a constant multiplied to each of the style loss function, the cyclic loss function, and the line loss function associated with the first generator 100 and the second generator may be larger than a maximum value of a constant multiplied to the adversarial loss function associated with the discriminator 200. In an embodiment, the total loss function may be defined by an [equation 8] below.

$${min}_{G} {max}_{D} {L}_{total} = {λ}_{style} {L}_{style} + {λ}_{line} {L}_{line} + {λ}_{cyc} {L}_{cyc} + {λ}_{adv} {L}_{adv} \qquad [ equation 8 ]$$

Where, G is the first generator 100 and the second generator 300, λ_{style}, λₗᵢₙₑ, λ_{cyc}, and lady are constants. For example, the λ_{cyc} may be about 10, and the lady may be about 1. In addition, the λ_{style} and the λₗᵢₙₑ may be operated according to [equation 9] below.

$${λ}_{style} = 5 - \frac{4.5 i}{n} , {λ}_{line} = 5 - \frac{4.5 i}{n} \qquad [ equation 9 ]$$

Where, i is a number of learned epochs, and n refers to a total number of learned epochs. 1 epoch is a learning once.

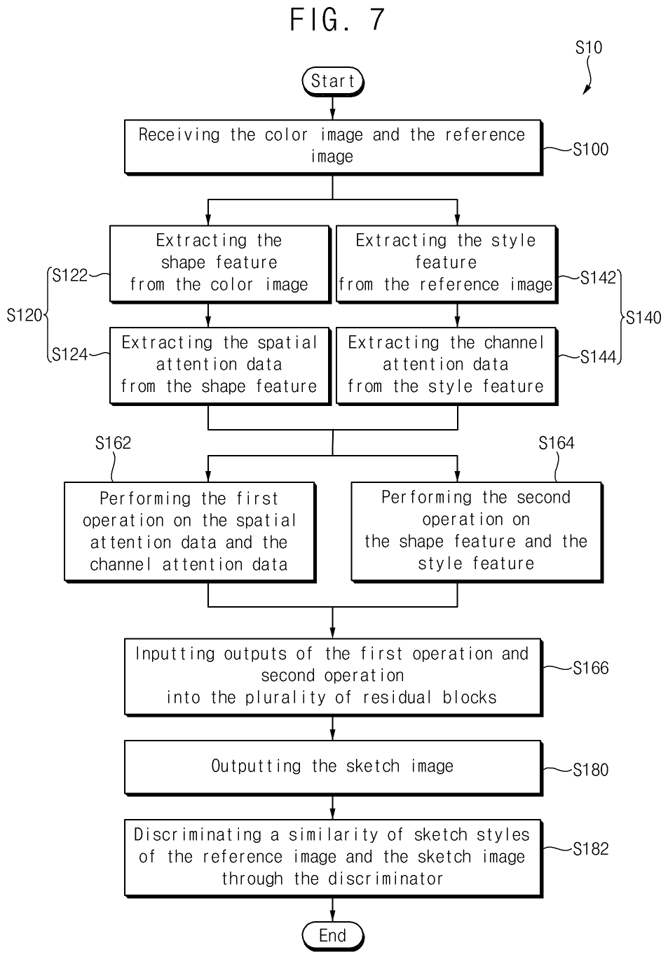

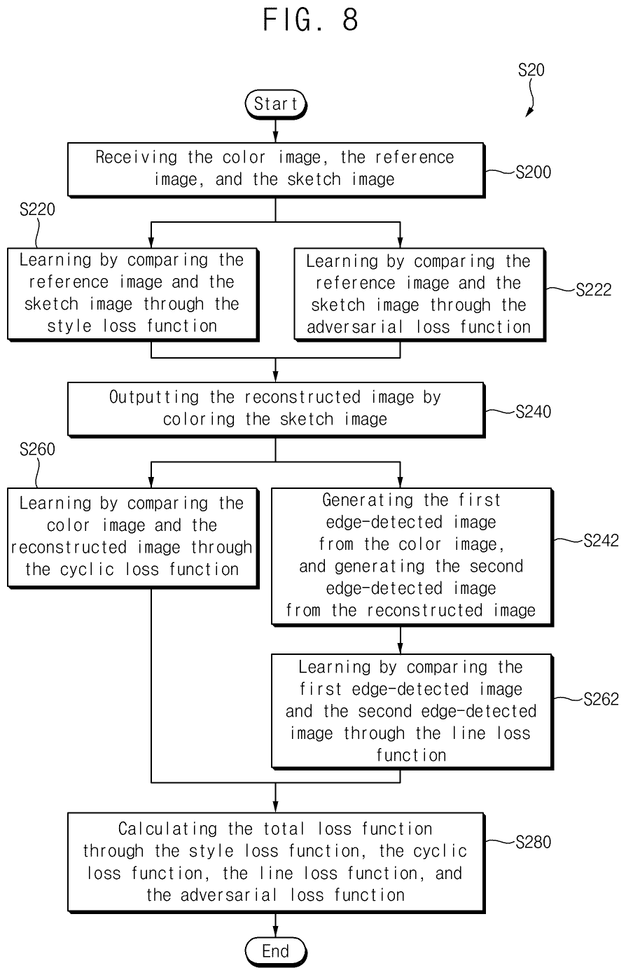

FIG. 7 is a flowchart illustrating a method of outputting a sketch image using the apparatus for automatically generating the sketch image of FIG. 1. FIG. 8 is a flowchart illustrating a method of learning a sketch image using the apparatus for automatically generating the sketch image of FIG. 1.

Hereinafter, contents overlapping with contents reference with FIGS. 1, 2, 3, 4, 5, and 6 will be omitted or simplified.

Referring to FIGS. 7 and 8, a method for automatically generating the sketch image according to an embodiment of present disclosure may include a method of outputting the sketch image S10 and a method of learning the sketch image S20.

Further referring to FIGS. 1, 2, 3, 4, 5, and 6, the method of outputting the sketch image S10 may be performed through the first generator 100 and the second generator 200. The method of outputting the sketch image S10 may include receiving the color image Cᵢ and the reference image Rᵢ S100, extracting a shape data from the color image Cᵢ S120, extracting a style data from the reference image Rᵢ S140, performing the first operation on the spatial attention data Dₛₚ and the channel attention data D_{ch} S162, performing the second operation on the shape feature F1 and the style feature F2 S164, inputting outputs of the first operation and second operation into the plurality of residual blocks 160 S166, outputting the sketch image O S180, and discriminating a similarity of sketch styles of the reference image Rᵢ and the sketch image O through the discriminator 200 S182.

The extracting the shape data from the color image Cᵢ S120 may include extracting the shape feature F1 from the color image Cᵢ S122 and extracting the spatial attention data Dₛₚ form the shape feature F1 S124. The extracting the style data from the reference image Rᵢ S140 may include extracting the style feature F2 from the reference image Rᵢ S142 and extracting the channel attention data D_{ch} from the style feature F2 S144.

The receiving the color image Cᵢ and the reference image Rᵢ S100 may be perform through the first encoder 122 and the second encoder 124. The extracting the shape feature F1 from the color image Cᵢ S122 may be performed through the first encoder 122. The extracting the style feature F2 from the reference image Rᵢ S142 may be performed through the second encoder 124. The extracting the spatial attention data Dₛₚ form the shape feature F1 S124 may be performed through the spatial attention block 142. The extracting the channel attention data D_{ch} from the style feature F2 S144 may be performed through the channel attention block 144.

The performing the first operation on the spatial attention data Dₛₚ and the channel attention data D_{ch} S162 may be perform through the first normalization operation block 146. For example, the performing the first operation on the spatial attention data Dₛₚ and the channel attention data D_{ch} S162 may be performed after the extracting the spatial attention data Dₛₚ form the shape feature F1 S124 and the extracting the channel attention data D_{ch} from the style feature F2 S144. In addition, the performing the second operation on the shape feature F1 and the style feature F2 S164 may be performed through the second normalization operation block 148. For example, the performing the second operation on the shape feature F1 and the style feature F2 S164 may be performed after the extracting the shape feature F1 from the color image Cᵢ S122 and the extracting the style feature F2 from the reference image Rᵢ S142.

In an embodiment, the performing the first operation on the spatial attention data Dₛₚ and the channel attention data D_{ch} S162 and the second operation on the shape feature F1 and the style feature F2 S164 may be performed simultaneously. Specifically, an output of the first operation and an output of the second operation may be simultaneously input into the plurality of the residual blocks 160, accordingly inputting the outputs of the first operation and the second into the plurality of the residual blocks 160 S166 may be performed.

The outputting the sketch image O S180 may be performed through the decoder 180. In the discriminating a similarity of sketch styles of the reference image Rᵢ and the sketch image O through the discriminator 200 S182, when the sketch styles of the reference image Rᵢ and the sketch image O are discriminated as a same or similar, the discriminator D may output a value close to 1. In the discriminating a similarity of sketch styles of the reference image Rᵢ and the sketch image O through the discriminator 200 S182, when the sketch styles of the reference image Rᵢ and the sketch image O are discriminated as a different, the discriminator D may output a value close to 0. However, the present disclosure may not be limited to this, and the discriminator 200 may output an another value.

The method of learning the sketch image S20 may be performed through the second generator 300 and the learner 400. The method of learning the sketch image S20 may include receiving the color image Cᵢ, the reference image Rᵢ, and the sketch image O S200, learning by comparing the reference image Rᵢ and the sketch image O through the style loss function S220, learning by comparing the reference image Rᵢ and the sketch image O through the adversarial loss function S222, outputting the reconstructed image Rₒ by coloring the sketch image O S240, generating the first edge-detected image HED(Cᵢ) from the color image Cᵢ, and generating the second edge-detected image HED(Rₒ) from the reconstructed image Rₒ S242, learning by comparing the color image Cᵢ and the reconstructed image Rₒ through the cyclic loss function S260, learning by comparing the first edge-detected image HED(Cᵢ) and the second edge-detected image HED(Rₒ) through the line loss function S262, and calculating the total loss function through the style loss function, the cyclic loss function, the line loss function, and the adversarial loss function S280.

The receiving the color image Cᵢ, the reference image Rᵢ, and the sketch image O S200 may be performed through the first learner 420 and the fourth learner 480. The learning by comparing the reference image Rᵢ and the sketch image O through the style loss function S220 may be performed through the first learner 420. The learning by comparing the reference image Rᵢ and the sketch image O through the adversarial loss function S222 may be performed through the fourth learner 480.

The outputting the reconstructed image Rₒ by coloring the sketch image O S240 may be performed through the second generator 300. The learning by comparing the color image Cᵢ and the reconstructed image Rₒ through the cyclic loss function S260 may be performed through the second learner 440.

The outputting the reconstructed image Rₒ by coloring the sketch image O S240, generating the first edge-detected image HED(Cᵢ) from the color image Cᵢ, and generating the second edge-detected image HED(Rₒ) from the reconstructed image Rₒ S242 and the learning by comparing the first edge-detected image HED(Cᵢ) and the second edge-detected image HED(Rₒ) through the line loss function S262 may be performed through the third learner 460.

The calculating the total loss function through the style loss function, the cyclic loss function, the line loss function, and the adversarial loss function S280 may be performed through the learner 400, and the apparatus for automatically generating the sketch image 1 may learn a process of extracting a sketch style from an input image.

As described above, in the method for automatically generating the sketch image using the apparatus for automatically generating the sketch image 1, the sketch image O which has a same shape as the color image Cᵢ and a same sketch style as the reference image Rᵢ may be generated from the color image Cᵢ and the reference image Rᵢ. Accordingly, the sketch image O may be generated when a shape of the color image Cᵢ and a shape of the reference Rᵢ image are different from each other, so a speed of generating the sketch image O using the automatic sketch image generation method may be improved.

In addition, in the method for automatically generating the sketch image, the reference image Rᵢ and the sketch image O may be compared and learned through the style loss function. Accordingly, a sketch style may be accurately extracted from an input image using the method for automatically generating the sketch image. In addition, in the method for automatically generating the sketch image, the sketch style may be more accurately extracted from the input image by calculating the total loss function using the style loss function, the cyclic loss function, the line loss function, and the adversarial loss function.

In an embodiment, a non-transitory computer-readable storage medium having stored thereon program instructions of the method for automatically generating the sketch image according to embodiments may be provided. The above mentioned method may be written as a program executed on the computer. The method may be implemented in a general purpose digital computer which operates the program using a computer-readable medium. In addition, the structure of the data used in the above mentioned method may be written on a computer readable medium through various means. The computer readable medium may include program instructions, data files and data structures alone or in combination. The program instructions written on the medium may be specially designed and configured for the present inventive concept, or may be generally known to a person skilled in the computer software field. For example, the computer readable medium may include a magnetic medium such as a hard disk, a floppy disk and a magnetic tape, an optical recording medium such as CD-ROM and DVD, a magneto-optical medium such as floptic disc and a hardware device specially configured to store and execute the program instructions such as ROM, RAM and a flash memory. For example, the program instructions may include a machine language codes produced by a compiler and high-level language codes which may be executed by a computer using an interpreter or the like. The hardware device may be configured to operate as one or more software modules to perform the operations of the present disclosure.

In addition, the above mentioned the method for automatically generating the sketch image may be implemented in a form of a computer-executed computer program or an application which are stored in a storage method.

Although the method and the apparatus according to the embodiments have been described with reference to the drawings, the illustrated embodiments are examples, and may be modified and changed by a person having ordinary knowledge in the relevant technical field without departing from the technical spirit described in the following claims.

1. A method for automatically generating a sketch image, the method comprising:
inputting a color image, and extracting a shape data from the color image;
inputting a reference image, and extracting a style data from the reference image; and
outputting the sketch image based on the shape data and the style data.

2. The method of claim 1, wherein the extracting the shape data comprises:
extracting a shape feature from the color image by a first encoder; and
extracting a spatial attention data from the shape feature by a spatial attention block.

3. The method of claim 2, wherein the extracting the style data comprises:
extracting a style feature from the reference image by a second encoder; and
extracting a channel attention data from the style feature by a channel attention block.

4. The method of claim 3, wherein a number of channels included in the shape data is equal to or greater than a number of channels included in the style data.

5. The method of claim 3, wherein the outputting the sketch image comprises:
performing a first operation of an adaptive instance normalization on the spatial attention data and the channel attention data;
inputting an output of the first operation into a plurality of residual blocks; and
generating the sketch image by inputting an output of the residual blocks into a decoder.

6. The method of claim 5, wherein the first operation is performed by a first normalization operation block, and
wherein an input of the first normalization operation block is a value obtained by performing a Hadamard product operation between the shape feature and the spatial attention data and a value obtained by performing the Hadamard product operation between the style feature and the channel attention data.

7. The method of claim 5, wherein the outputting the sketch image further comprises:
performing a second operation of the adaptive instance normalization on the shape feature and the style feature; and
inputting an output of the second operation into the plurality of residual blocks.

8. The method of claim 5, further comprising:
learning a process of extracting a sketch style from an image based on the color image and the reference image, and
wherein the process of extracting the sketch style from the image is learned based on a loss function.

9. The method of claim 8, wherein the loss function includes a style loss function, and
in the learning the process, the style loss function compares the reference image and the color image.

10. The method of claim 9, wherein the style loss function performs an operation according to an [equation 1] below:
$${L}_{style} = {E}_{O , {R}_{i}} [ {‖ {C}_{w} ( O ) - {C}_{w} ( {R}_{i} ) ‖}_{1} ] \qquad [ equation 1 ]$$
where, L_{style} is the style loss function, C_{w} is a pre-trained model, Rᵢ is the reference image, and O is the sketch image.

11. The method of claim 9, further comprising:
outputting a reconstructed image by coloring the sketch image after the outputting the sketch image.

12. The method of claim 11, wherein the loss function includes a cyclic loss function, and
in the learning the process, the cyclic loss function compares the color image and the reconstructed image.

13. The method of claim 12, wherein the cyclic loss function performs an operation according to an [equation 2] below:
$${L}_{cyc} = {E}_{{C}_{i} , {R}_{o}} [ {‖ {C}_{i} - {R}_{o} ‖}_{1} ] \qquad [ equation 2 ]$$
where, L_{Cyc} is the cyclic loss function, Cᵢ is the color image, and R_{O} is the reconstructed image.

14. The method of claim 11, wherein in the learning the process,
a first edge-detected image is generated from the color image through an edge-detection process, and
a second edge-detected image is generated from the reconstructed image through the edge-detection process.

15. The method of claim 14, wherein the loss function includes a line loss function, and
in the learning the process, the line loss function compares the first edge-detected image and the second edge-detected image.

16. The method of claim 15, wherein the line loss function performs an operation according to an [equation 3] below:
$${L}_{Line} = {E}_{{C}_{i} , {R}_{o}} [ {\sum }_{l} {‖ {∅}_{l} ( HED ( {C}_{i} ) ) - {∅}_{l} ( HED ( {R}_{o} ) ) ‖}_{1} ] \qquad [ equation 3 ]$$
where, Lₗᵢₙₑ is the line loss function, HED(Cᵢ) is the first edge-detected image, HED(R_{O}) is the second edge-detected image, and Øₗ is an activation map located in a lth layer of a deep learning network for comparing the first edge-detected image and the second edge-detected image.

17. The method of claim 8, wherein the loss function includes an adversarial loss function,
the method further comprising:
discriminating a similarity of a sketch style of the reference image and a sketch style of the sketch image through the adversarial loss function by a discriminator.

18. The method of claim 17, wherein the adversarial loss function performs an operation according to an [equation 4] below:
$${L}_{adv} = {E}_{{R}_{i}} [ log ( D ( {R}_{i} ) ) ] + {E}_{O} [ log ( 1 - D ( O ) ) ] \qquad [ equation 4 ]$$
where, L_{adv} is the adversarial loss function, D is the discriminator, Rᵢ is the reference image, and O is the sketch image.

19. An apparatus for automatically generating a sketch image comprising:
a first generator configured to receive a color image and a reference image and configured to output the sketch image which has a same shape as the color image and a same sketch style as the reference image; and
a discriminator configured to discriminate a similarity of a sketch style of the reference image and a sketch style of the sketch image.

20. A non-transitory computer-readable storage medium having stored thereon program instructions, which when executed by at least one hardware processor, performs the method of claim 1.
